(19) United States
(12) Patent Application Publication
(10) Pub. No.: US 2005/0236792 A1
(43) Pub. Date: Oct. 27, 2005

(54) Stabilizing air suspension system

(76) Inventor: William E. Hedenberg, Cox's Creek, KY (US)

Correspondence Address: Leo J. Aubel, 111 Rivershire Lane, Lincolnshire, IL, 60069, US

(21) Appl. No.: 11/167,808

(22) Filed: Jun. 27, 2005

Related U.S. Application Data
(63) Continuation-in-part of application No. 10/718,229, filed on Nov. 20, 2003.

(51) Int. Cl. B60G 3/00

(52) U.S. Cl. 280/124.11

(57) ABSTRACT

An improved air suspension system for the rear axle of a vehicle such as a light to medium duty truck. The system includes a torque arm extending forward of the axle with its forward end mounted on the frame and an intermediate point mounted on the axle. The rear end of the torque arm extends rearwardly of the rear axle and said rear end comprises a bracket that is offset and supports the forward end of a lever arm. The rear end of the lever arm is mounted on a shackle affixed to the chassis. An air spring is mounted on the lever arm and the air spring and lever arm support major portion of the vehicle weight.

This application is a continuation in part of U.S. patent application Ser. No. 10/718,229 filed on Nov. 2, 2003 by William E. Hedenberg,the same inventor hereof.

### BACKGROUND OF INVENTION

The present invention relates to an air suspension system of the type shown in U.S. Pat. No. 4,518,171, also issued to William E. Hedenberg, that provides for improving the ride and stability of vehicles and for maintaining the vehlicle level during acceleration and deceleration. U.S. Pat. No. 4,518,171 provided an air suspension system having a pair of torque rods that were pivotally attached to the axle housing and extended forward of the rear axle in a modified parallelogram linkage. The air suspension system included a lever arm extending rearwardly of the axle. The forward end of the lever arm was mounted underneath the axle and the rear end of the lever arm was pivoted on a hanger assembly. An air bag was mounted on the lever arm, and the air bag supported 100% of the load on the vehicle. The system of U.S. Pat. No. 4,518,171 operated excellently; however, the system was costly and it is the purpose of the present invention to provide a system which provides similar operating characteristics, but with a design that is much more simplified and economical.

### SUMMARY OF INVENTION

An air suspension system for use with vehicles such as vans, pick-up trucks, and ambulances is disclosed. The system includes a cantilever arm that has its forward end mounted on the vehicle chassis at a position forward of the rear axle. The cantilever arm extends back toward the rear axle and is mounted over the rear axle and the rear end of the torque arm extends rearwardly past the rear axle. The system includes a rearwardly extending lever arm that has its forward end supported on the rear end of the cantilever arm. The lever arm extends rearwardly of the rear axle, and in a preferred embodiment the rear end of the lever arm is mounted to a shackle that is in turn mounted on the vehicle chassis. An air spring is mounted intermediate the ends of the lever arm. The air spring and the lever arm support the weight of the vehicle chassis and the load.

The foregoing features and advantages of the present invention will be apparent from the following more particular description of the invention. The accompanying drawings, listed herein-below, are useful in explaining the invention.

### DESCRIPTION OF THE DRAWINGS

FIG. 1 labeled prior art shows a side view of applicant's. prior invention disclosed in U.S. Pat. No. 4,518,171;

FIG. 2 shows a side view of one embodiment of the inventive system mounted on the frame of a vehicle such as a pick-up truck;

FIG. 3 show details of the bracket that supports the lever arm of FIG. 2;

FIG. 4 shows a variation in the placement of the bracket of FIG. 3 for mounting on the cantilever arm;

FIG. 5 shows a vehicle frame useful showing one positioning of a mechanical height control mechanism;

FIG. 6 shows a side view of a preferred embodiment of the inventive system mounted on the frame of a vehicle such as a pick-up truck;

FIG. 7 is an isometric view of the cantilever arm particularly to show the angled orientation of the end of the cantilever arm to provide an offset mounting as used in the embodiment of FIG. 6;

FIG. 8 is a top view of the cantilever arm and the rear lever arm to more clearly show the offset mounting of the rear lever arm with respect to the cantilever arm;

FIG. 9 is an inventive flow control mechanism useful for the disclosed air suspension systems, and useful as well for prior art type air suspension systems.

### DESCRIPTION OF THE INVENTION

FIG. 1, labeled Prior Art, shows the structure of applicant's previous invention as disclosed in U.S. Pat. No. 4,518,171 and briefly described above. As mentioned above, the system shown in FIG. 1 functions extremely well, however it is bulky and expensive, and might be said to be over engineered.

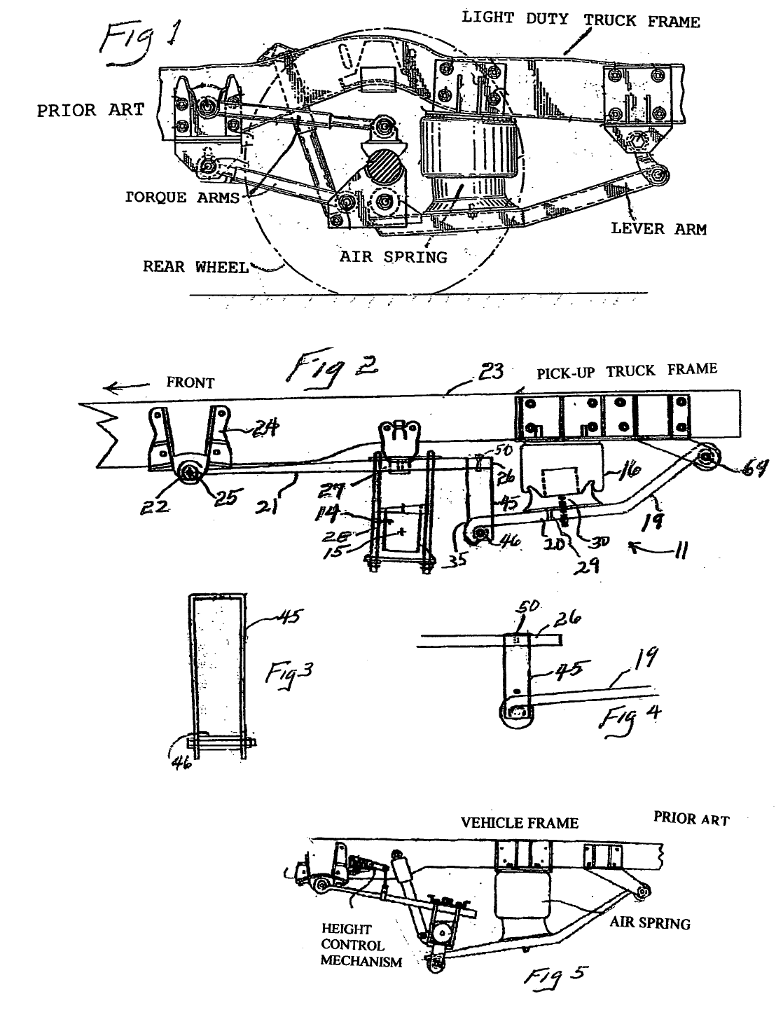

Refer now to FIG. 2 that shows one embodiment of the inventive air suspension system 11 that is particularly useful for the medium-to-light duty vans and trucks from ¾ ton up to a 15,000 pound weight on the rear drive axle. The invention is for vehicles having two axles. The air suspension system 11 is depicted as installed on the chassis or frame 23 of a vehicle adjacent the left rear wheel 36 (see FIG. 8) and on the rear axle housing 14 for rear axle 15 of the truck frame 23. It will, of course, be understood that a similar air suspension structure which comprises the other or right side of the system is installed adjacent to the right rear wheel on the rear axle housing 14 of the vehicle.

The air spring for the system 11 comprises a vehicle air spring (bag) 16 of any suitable known type, and is selected dependent on the carrying capacity of the vehicle. The air spring 16 is mounted on an elongated lever arm 19 by a suitable base (seat) 30, and the top of the air spring 16 suitably mounts underneath the chassis 23. Lever arm 19 extends longitudinally of the vehicle and transverse to the rear axle housing 14. The lever arm 19 which is in the form of a solid beam may also comprise one or more leafs of spring steel.

The system 11 is installed in a trailing lever arm position; i.e., the air spring 16 is directly mounted on the lever arm 19 which is mounted to extend rearwardly of the rear axle housing 14 (rearwardly relative to the longitudinal orientation of the vehicle). An intermediate section 20 of the lever arm 19 provides the mounting area for the base 30 of the air spring 16.

As further shown in FIG. 2, the system 11 includes a torque arm 21 that, in one embodiment, comprises a single straight and elongated beam/bar member; torque arm 21 may also be of spring steel. The forward end 22 of torque arm 21 comprises a loop or spring eye and is pivotally mounted on a bushing 25, held by a suitable bracket 24. Bracket 24 is affixed to the chassis 23. An intermediate section 27 of torque arm 21 is mounted on the axle housing 14 by a suitable U-bolt assembly 28. The rear end 26 of torque arm 21 extends rearwardly of the rear axle housing 14. An inverted U-shaped bracket 45, see also FIG. 3, has its bight mounted on the rear end 26 of torque arm 21. A bolt/bushing assembly 46 extending through the spaced arms of U-shaped bracket 45 supports the end 35 of the lever arm 19.

The forward end 35 of lever arm 19 may be generally in the form of an backward “C”, rather than a closed loop. The “C” configuration appears to reduce the friction between the end 35 of lever arm 19 and the bolt/bushing 46.

Refer now to FIG. 4. By relocating the position of the bracket 45, forward a short interval of about two to four inches on the torque arm 21, other weight bearing parameters for the air suspension system are obtained. This is readily done by providing different mounting holes for bolt 50, as indicted in FIG. 4. This positions the forward end of the lever arm 19 relatively closer to the rear axle, and also positions the air spring 16 slightly closer to the rear axle housing 14.

A second and preferred embodiment of the inventive system is shown in FIG. 6. In this embodiment the cantilever arm 21A comprises an elongated steel beam or bar 26A that has a forward section extending parallel to the truck chassis 23. The front of the truck frame is indicated by the arrow line 40. An eye or loop 22A is formed on the forward end of beam 26A to mount the forward end to chassis 23 via bushing 25A. The rear end 26B of the cantilever arm 21A has a downwardly dependent bracket 45A that is affixed, as by welding, to the end of the beam 26A, see also FIG. 7. Essentially, the bracket 45A is a part of the cantilever arm 26A. Importantly, and as shown in FIG. 7, the rear end 26B of the cantilever arm 21A is angled inwardly such that bracket 45A is offset (labeled 57) from the longitudinal axis of beam 26A. Bracket 45A is an inverted U-shaped member that includes a bight or top 54 and two downwardly depending arms 55 and 56. A bolt/bushing assembly 46A (see FIG. 6) is mounted between arms 55 and 56 (similarly to the structure shown in FIG. 3) to support the forward end of the lever arm 19A in the offset configuration.

FIG. 8 more clearly shows the offset 57 provided by bracket 45A to support the forward end of the lever arm l9A. Such offset is necessary to provide the clearance between the chassis and the vehicle tires 36 to mount the air spring 16. The rear end of lever arm 19A includes an eye/loop 48 that is mounted on a shackle 47. Shackle 47 enables the articulation of lever arm 19A. In one embodiment this articulation is approximately 0.75 inch.

It has been found that the mounting of the air spring 16 on the lever arm 19A (or 19) will reduce the natural frequency of the air spring by approximately 12-15%; however, the presently used common trailing arm arrangement will increase the natural frequency of the air spring by about 12-15%. The air spring supports and isolates approximately 95% of the chassis load and road vibration. In effect, by merging the mechanical set-up of the two elements, the mechanical arrangement of this invention causes one factor to cancel out the other. The result is that the air spring maintains its initial natural characteristics of rate and frequency, in a one to one relation.

Note, of course, that the torque arm 21A (or 21)and, or the lever arm 19A (or 19) may varied in length to accommodate various models of vehicles.

The arrangement of the torque arm clamped to the axle and forward to a pivot causes this system to become “torque reactive”. This method prevents axle “wind-up”, chassis pitch or rear-end squat during acceleration and front-end nose-dive upon braking. This check of axle “wind-up” will maintain a constant pinion angle that eliminates drive-line vibration and prolongs universal joint life. Also, the rigid clamp of the torque arm at the axle prevents chassis roll and yaw, thus eliminating the need of a roll or sway bar assembly.

Note also that the position of the air spring 16 can be positioned on the chassis 23 and on the lever arm 19A dependent on the load bearing requirements by providing various attachment points. The load characteristics of the system 11 can be conveniently tailored for several load bearing classes of vehicles.

Further, the geometric arrangement of the lever arm reduces the air spring vertical travel 25% less than that of the axle, thus prolonging the life of the air spring.

In one embodiment of the invention, as shown in FIG.6, tests have indicated that the lever arm and air spring supports and isolates 78% of the chassis load and road vibrations. More specifically, the forward end of the lever arm is vertically connected at the rear end of the cantilever arm. This construction displaces approximately 22% of the chassis load into the cantilever arm and hanger bracket forward of the axle. The following calculations were made on the aforementioned embodiment. The distance from the center of forward hanger bracket 24 and center of the cantilever bushing 25 to the center of the axle 16 is 24.92 inches. The distance from the forward hanger bracket 24 and center of the cantilever bushing 25 to the center of member 45 is 31.94 inches The distance of 24.92 inches divided by the distance of 31.94 inches gives the decimal 0.78; hence, the system provides a 0.78 lifting ratio at the rear shackle position 69 of lever arm 19A and a 0.22 percentage vertical load at the front hanger bracket 24.

In the aforesaid embodiment, the measurement between the center of member 45A and the forward end of the lever arm 19A to the center of the air spring is 9.88 inches. The center of the air spring center to lever arm rear pivot center (bushing 69) is 19.13 inches. The distance between the member 45A and the forward pivot point of the lever arm 19 to the rear pivot center of the lever arm is 29.01 inches. The 29.01 inches divided by 19.12 inches results in a 1.51 lever arm ratio.

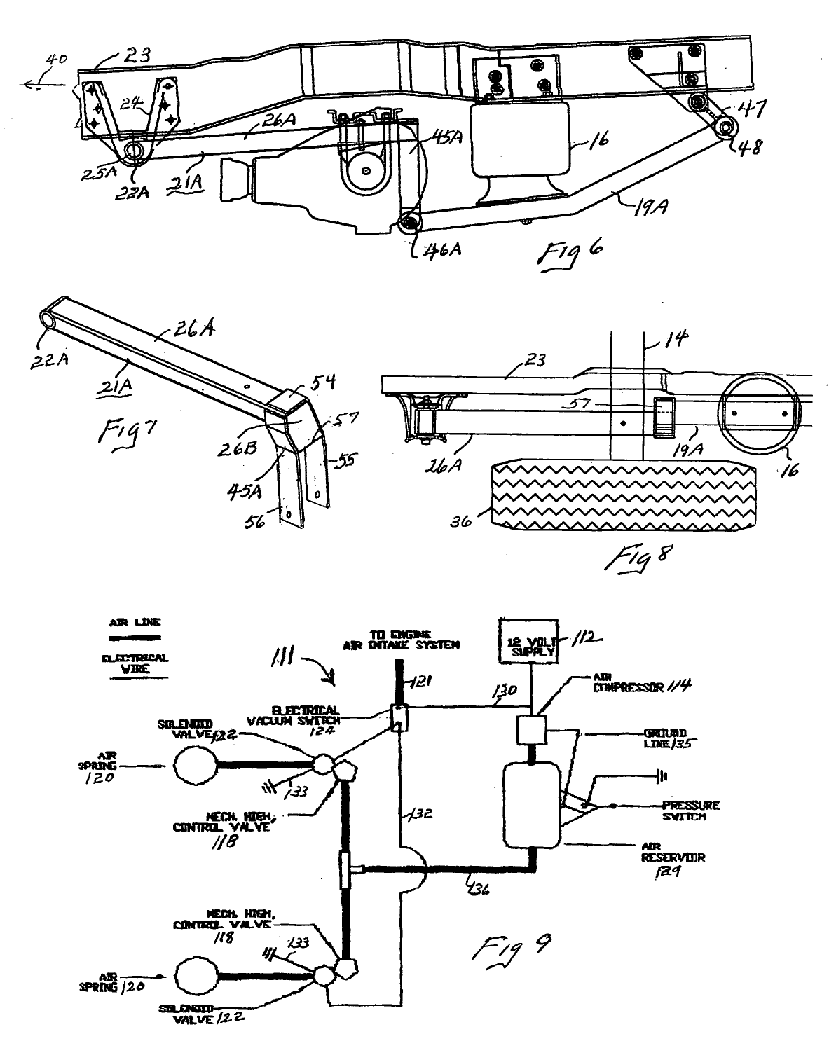

Refer now to FIG. 9 that shows a control system for maintaining the level of the truck frame during acceleration and deceleration. It has been found that upon acceleration, torque on the axle of a vehicle that is equipped with a drive axle air suspension system, a torque reactive system, will cause the vehicle's rear frame to raise. Refer now to FIG. 5, labeled prior art. On those vehicles that have a height control valve that controls the air pressure to the air spring, as in FIG. 5, the acceleration changes the position of the lever arm of the control valve which in turn causes air to exhaust from the air spring, having an effect on the air springs weight bearing characteristics. Conversely, upon deceleration, the axle torque is reduced and the vehicles rear frame will fall in an attempt to return to its initial preset ride position. However, due to the loss of air in the air spring the vehicles frame will sag further below it's designed ride height. In this lowered position the mechanical height control valve will allow air to flow into the air spring attempting to replenish the air spring with sufficient air volume to regain it's proper weight support attitude.

These vertical sequences of the frame and axle are continual during city (urban) driving. Within a short period, this consistent cycling will have occurred tens of thousands of times which causes excessive wear on the air springs, shocks, pivot bushings, mechanical height control valves, and air compressors, as well as yielding undesirable air suspension performance.

Accordingly, it is useful to provide some time delay in the operation of an air suspension system during the acceleration and deceleration cycles in order to prevent excessive wear to the components. Presently, most height control valves do not provide any time delay, and are termed “zero delay” valves. This type of valve is less complex and therefore less expensive. A few height control valves deliver from one to a maximum six second time delays; however, even those valves that have up to a six second time delay cannot control the continual action of the air suspension system in a city driving; essentially a valve with a minimum delay feature of at least eight seconds is needed.

Note also, in city driving, vertical axle articulation is more leisurely which also contributes to air loss in the air spring. Tests made on those with vehicles that require a 12 volt air compressor as the source of air pressure have revealed that the first component to fail in air suspension systems for light duty vehicles is the 12 volt compressor.

Vehicles equipped with OEM steel leaf springs employing “air helper kits” and mechanical control valves can encounter the similar axle action as in the “torque reactive system. In vehicles using steel leaf springs during acceleration and/or braking the steel leave springs allows axle “wind-up” which also displaces the axle to undesired frame and height control positions.

A height control mechanism for the inventive air suspension system is shown in FIG. 9. The height control sub-system provides a minimum of eight seconds delay response in the activation of the air suspension system thereby minimizing the wear and tear on the components of the air suspension system. FIG. 5 depicts a prior art mechanical height control mechanism affixed to a vehicle frame and is included herein for reference and explanation purposes.

FIG. 9 is a schematic diagram of the height control delay sub-system 11, showing the various components and indicating the air line connections and the electrical connections. The operation of the height control delay system is determined, or controlled by the vehicles engine which may be either a gas or diesel engine. The delay system becomes operational upon the application of engine torque, preventing air flow (in or out) of the air spring. The system will remain functional during continuous applied drive torque of the vehicle engine. At the moment of deceleration, the system will remain energized, thereby checking air flow at the air spring for a minimum of eight seconds, then the control system becomes passive. This passive or dormant stage of the delay system enables the vehicles frame and the mechanical height control valve to recover to the preset ride position without any air loss from the air spring or reservoir. Referring to FIG. 5, it will be appreciated that acceleration or deceleration will cause the vehicle frame to move relative to the axle and hence cause upward and downward vertical action of the air spring; and, further repeated acceleration and deceleration as in an urban environment can cause excessive functioning of the air spring and the associated components.

The delay system is inactive at engine idle condition, thereby allowing the mechanical height control valve to function during loading and unloading of the vehicle.

The inventive delay system 111 of FIG. 9 includes a typical 12 volt supply (battery or regulator)112 provided for the air compressor 114, air reservoir 116, two mechanical height control valves generally labeled as 118, and the two air springs, generally labeled 120. As depicted in FIG. 9, the delay system 111 is connected through an electrical vacuum switch module 124 and air hose or line 121 to the engine air intake system. The electrical module 124 comprises a differential air pressure vacuum sensing switch with fixed set point range. Module 124 includes an internal preloaded spring diaphragm which operates a normally open electrical switch contact. One end of the air hose 121 is connected to the low pressure inlet of the switch module 124 and the opposite end is connected or inserted into the engine air intake of an automotive vehicle on which the associated air suspension system including springs 120 is mounted.

The electrical module 124 is connected via line 130 to the electric supply 112 of the vehicle. Electrical wiring 132 also connects the module 124 to the two, normally open, air solenoid valves 124. The solenoid valves both have a ground connection 133 to the vehicle chassis. Compressed air is supplied from the air compressor 114 via air line 134 to the air reservoir 129, and from the air reservoir 129 through air line 136 and a tee junction 137 to the mechanical height control valves 118, through the solenoid valves 122 and into the air springs 120. Instantly and upon applying foot pressure on the vehicle accelerator, the engine RPM will immediately increase causing the engines air (vacuum) intake to substantially increase the vacuum that activates the diaphragm of module 124 and its electrical switch to close and couple 12 volts to the solenoid valves 122 which close and prevent the air flow in or out of the associated air spring 120.

Upon releasing foot pressure on the vehicles accelerator, the engine RPM and air (vacuum) intake will diminish thereby causing the vacuum pressure on the spring loaded diaphragm in module 124 to decrease. When the vacuum is decreased at the module 124, the spring diaphragm will delay approximately eight seconds to deactivate the electrical switch in module 124. When the electrical contact in module 124 opens, the12 volts supply to the air solenoid valves 122 is cut-off, which will in turn cause the solenoid valves to open thereby permitting air flow at the air springs 120. Note that there is a minimum of an eight second delay in permitting air flow at the springs.

With engine torque (RPM) higher than at idle, be it by foot pressure on the vehicles accelerator or with the vehicles “cruise control” activated, the engine air intake will continuously activate the electrical vacuum module 123, the solenoid valves 122 and prevent air loss or intake at the air springs 120.

By connecting the 12 volt solenoid valves to the vehicles brake light system, further air flow loss, is prevented upon braking. While air loss caused by braking has not been a problem when using an air suspension system, the inventive delay system might be considered an additional added benefit for air suspension systems.

Testing of the delay system has been conducted in urban and highway driving, vehicle loading, unloading, acceleration and braking. The system has been subjected to rain, snow, ice and temperatures of 100 degrees above and 30 degrees below Fahrenheit.

Further, in an attempt to verify life expectancy and performance in the most difficult situations, various components of the system were mounted on the outside of the test vehicles frame rail exposing it to all road elements. The test vehicle has experienced year round conditions including summers and winters, and accumulated over forty thousand miles. The 12 volt air compressor and the delay system components all operated satisfactorily throughout a testing period of thirty six months. Importantly, the air compressor in the inventive delay system, operates only as needed under controlled of the delay system, hence extended operating life is assured.

When the air supply components of the suspension system are properly installed air demand for the air suspension from the compressor will only be required when a load is applied to the vehicle. Air may occasionally be needed to top off the air supply in the reservoir for example when the vehicle has been on a prolonged idle period.

While the invention has been particularly shown and described with reference to preferred embodiments thereof, it will be understood by those skilled in the art that various changes in form and details may be made therein without departing from the spirit and scope of the invention.

1. An air suspension system for a vehicle having a chassis, a front axle housing and a rear axle housing; said system comprising;
a) an cantilever arm having a forward end, an intermediate section and a downwardly extending rear end; the forward end of said cantilever arm being pivotally mounted to said chassis, said intermediate section being mounted over said rear axle housing and the rear end of said torque arm extending rearwardly of said rear axle housing;
b) an lever arm having a forward end, an intermediate section and a rear end;
c) a shackle assembly mounted to said chassis;
d) said lever arm having its rear end mounted to said shackle; and
e) an air spring mounted on said intermediate section of said lever arm between said lever arm and said chassis to provide load support to said chassis.

2. An air suspension system for a vehicle having a chassis and front and rear axle housings, said system comprising,
a) an cantilever arm having a forward end, an intermediate section and a rear end;
b) means for pivotably mounting the forward end of said cantilever arm to said chassis;
c) means for fixedly mounting the intermediate section of said torque arm on said rear axle housing,
d) said rear end of said cantilever arm extending rearwardly of said rear axle housing;
e) a bracket mounted to the rear end of said cantilever arm and extending downwardly from said cantilever arm;
f) a lever arm having a forward end, an intermediate section and a rear end;
g) said bracket supporting said forward end of said lever arm;
h) a shackle assembly mounted on said chassis for pivotably supporting the rear end of said lever arm;
i) an air spring mounted on said intermediate section of said lever arm between said lever arm and said chassis to provide load support to said chassis.

3. An air suspension system as in claim 1 wherein
a) said rear end of said cantilever comprises a bracket that is in position rearward and adjacent said axle for supporting the forward end of said lever arm.

4. An air suspension system as in claim 1 wherein said shackle assembly is fixedly mounted on said chassis, and said lever arm is pivotably mounted on said shackle assembly to thereby allow said lever arm to articulate.

5. An air suspension system as in claim 2 wherein said bracket is movable on said cantilver arm to provide different lifting characteristics.

6. An air suspension as in claim 1 wherein the rear end of said lever arm contacts said shackle assembly at angle to enable articulation of said lever arm.

7. An air suspension system as in claim 1 wherein the rear end of said cantilever arm formed as an angle and said bracket is offset from the axis of said arm to thereby support said lever arm relatively offset from the longitudinal axis of said cantilever arm.

8. An air suspension system as in claim 1 wherein said shackle assembly enables an articulation action of about an inch.

9. A vehicle height control system for a light duty vehicle utilizing an air suspension system wherein said air suspension system includes air springs mounted on the rear axle of the vehicle, said air springs being mounted adjacent each wheel on said rear axle housing, said air suspension system further including an air compressor, and height sensors on said vehicle for responding to the load on said vehicle and for controlling the air pressure provided to said air springs, said height control system comprising,
a) and electrical differential pressure responsive vacuum switch having an input connected to the engine air intake system and responding thereto;
b) switching means for providing an electrical output in response to said engine air intake system;
c) solenoid valves connected between the air reservoir of said air suspension system;
d) mechanical height control valves positioned to be responsive to the position of the vehicle frame;
e) solenoid valves electrically connected to said switch means, said solenoid valves providing a minimum of an eight second time delay when actuated in response to said electrical switching means; and
f) said mechanical control valves coupling air from said reservoir to said air spring via said mechanical control valves to pause stop said air spring from receiving or exhausting air for at least said eight seconds such as during acceleration and deceleration of said vehicle frame.

10. A height control system as in claim 9 wherein said system is useful for a variety of air suspension systems.
